(19) United States
(12) Patent Application Publication
(10) Pub. No.: US 2010/0166451 A1
(43) Pub. Date: Jul. 1, 2010

(54) TONER DUST FILTER

(75) Inventors: Harald Von Schischka, Oestringen (DE); Juergen Adolph, Stockstadt (DE); Steffen Grunz, Ilvesheim (DE); Thorsten Schmitt, Weinheim (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/664,672

(22) PCT Filed: May 29, 2008
(86) PCT No.: PCT/EP08/04269

§ 371 Date: Dec. 15, 2009

(30) Foreign Application Priority Data
Jun. 15, 2007 (DE) 102007028262.3

(51) Int. Cl. G03G 21/00

(52) U.S. Cl. 399/98

(57) ABSTRACT

A printer (1) with a toner-based printing device, the printer (1) comprising at least one air outlet (2), to which a filter (3) is fastened exchangeably, for the outflow of the gas contained in the printer (1) into the surroundings, the filter (3) comprising at least one electrostatically active filter ply (4).

### TECHNICAL FIELD

Printer with a toner-based printing device, the printer comprising at least one air outlet, to which a filter is fastened exchangeably, for the outflow of the gas contained in the printer into the surroundings.

### PRIOR ART

Printers of this type are in widespread use in connection with computers at office workstations. In this context, predominantly fan-cooled laser printers are employed, air mixed with particles flowing out of the air outlet during the printing operation. The emitted particles, which are mostly toner dust particles, are in a diameter range up to a minimum of 0.1 μm. It is therefore fine dust which may be a health risk. This presents problems especially when single-user printers are concerned which are located in the vicinity of workstations. Usually, printers of this type are not equipped with a filter device for the filtration of outflowing air. Furthermore, there is the problem that such small particles cannot be retained by many known filter media.

### PRESENTATION OF THE INVENTION

The object on which the invention is based is to provide a filter for a printer, which filter retains the toner dust emitted by the printer reliably and over a long service life.

This object is achieved by means of the features of claim 1. The subclaims relate to advantageous refinements.

To achieve the object, the filter comprises at least one electrostatically active filter ply. Such a filter ply has the advantage that, because of the electrostatic interaction with the particles, it has a high separation capacity, while at the same time having low admission resistance. In this case, in particular the low admission resistance is advantageous, since especially single-user printers are equipped with cost-effective fans which allow only a low volume flow in the case of high counterpressure. As a result, filter media having a high admission resistance cannot be used here. The filter ply according to the invention has, in particular, a good separation capacity in the case of particles larger than 0.1 μm. The particles can in this case penetrate into the electrostatically active filter ply, thus resulting, depending on the thickness of the filter ply, in a long service life of the filter. The filter ply may be formed, in particular, from nonwoven. Nonwovens are in widespread use as filter media and can be produced cost-effectively. The filter material consisting of nonwoven, which comprises electrostatically charged fibers, is generally referred to as electret filter material.

To produce electret filter material, various polymer fibers are mixed with one another and consolidated by means of needling. On account of high friction, the fibers which have polymers of different electronegativities are differently charged electrostatically and consequently have different electrostatic filter activity. The electrostatically active filter ply is therefore formed from a mixture of positively and negatively charged individual fibers. The polymer fibers may also be consolidated thermally or by means of a water jet method. Electrostatic charging can then take place by means of plasma treatment. Against this background, it is conceivable to produce the fibers by means of a melt-blown method.

It is especially advantageous that, in electret filter material, fine particles can be filtered along with a low pressure loss. On account of the electrostatic interaction, with the filter capacity being the same, the pores can be made larger than in non-charged filter material. Electret filter material has electrostatic filter activity without auxiliary energy being supplied. Electret filter material has a long useful life and is cost-effective. The filter according to the invention is suitable especially for use on single-user printers.

The filter may be designed as a folded filter. Folded filters have, in relation to the base area, a larger filter area than filter media of planar form. The service life of the filter is thereby further improved.

The filter may comprise at least three filter plies, the middle filter ply of which is the electrostatically active filter ply. In this refinement, the first filter ply faces the printer and the third filter ply faces the surroundings. The first filter ply forms a pre-filter in which coarser constituents are retained from the airstream. In the subsequent middle electrostatically active filter ply, the fine particles which have passed through the pre-filter are retained. The final third filter ply facing the surroundings forms a covering ply and protective layer which protects the first and the second filter ply against damage emanating from the surroundings. The filter plies may be connected to one another in a materially integral manner. The third filter ply may serve as a base for an electrostatically active filter ply generated by means of the melt-blown method. Filter plies of this type can be produced particularly quickly.

The filter may comprise a ply equipped with activated charcoal. Printers may also emit, during operation, gaseous constituents which constitute a health risk. The ply equipped with activated charcoal can retain such constituents which constitute a health risk. For this purpose, the activated charcoal may also be additionally equipped or pretreated with auxiliary substances in order to improve the separation capacity with respect to specific gases in a constituent.

The filter may comprise a frame consisting of nonwoven which is adhesively bonded to the at least one filter ply. A frame consisting of nonwoven can be produced simply and cost-effectively. The frame stiffens the filter structure.

Plastic angles may be provided on the end faces of the filter. The plastic angles stiffen the filter and prevent the situation where the filter may be compressed transversally to the folds. Furthermore, they simplify the mounting of the filter. The plastic angles are formed, in particular, as injection moldings which can be produced simply and cost-effectively.

The plastic angles may have a face which points in the direction of the printer and which is equipped with an adhesive strip. This adhesive strip may be, in particular, a double-sided adhesive tape, the adhesive strip being designed such that the filter can simply be fastened to the printer and also removed again entirely.

### BRIEF DESCRIPTION OF THE DRAWING

Some exemplary embodiments of the printer according to the invention are explained in more detail below with reference to the FIGURE in which:

FIG. 1 shows diagrammatically a printer equipped with a filter according to the invention.

### IMPLEMENTATION OF THE INVENTION

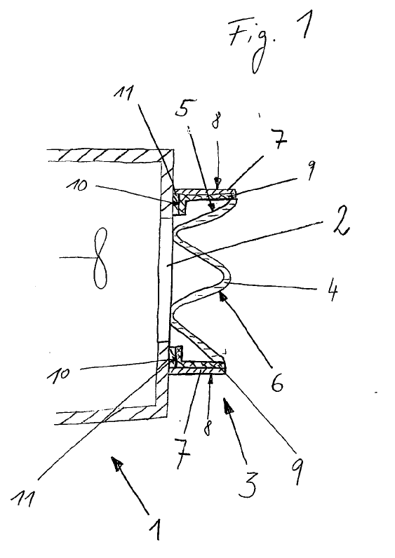

FIG. 1 shows a printer 1, here a single-user laser printer with a toner-based and fan-cooled printing device. The printer 1 has an air outlet 2 for the outflow of the gas contained in the printer 1 into the surroundings. A filter 3 is fastened exchangeably to this air outlet 2. The filter 3 is designed as a folded filter and consists of a nonwoven. The filter 3 has three filter plies 4, 5, 6. The first filter ply 5 of these faces the printer 1. The first filter ply 5 consists of nonwoven and forms a pre-filter which retains coarser particles. The middle filter ply 4 likewise consists of nonwoven. This is in the form of electret filter material and is thereby electrostatically active. The toner dust is retained by the middle filter ply 4. The third filter ply 6 faces the surroundings. This filter ply 6 forms a protective and covering layer and protects the other filter plies 4, 5 against external influences. In other refinements, a further filter ply may be provided which is equipped with activated charcoal. The filter plies 4, 5, 6 are surrounded circumferentially by a nonwoven strip which is adhesively bonded to the filter plies 4, 5, 6. This nonwoven strip forms the frame 7 of the filter 3. For additional stiffening, plastic angles 9 are provided on the end faces 8 of the filter 3. These plastic angles 9 have a face 10 which points in the direction of the printer 1 and which is equipped with an adhesive strip 11, here a double-sided adhesive tape. The filter 3 according to the invention is also suitable for use on other office appliances, for example copiers, which likewise emit particulate constituents.

What is claimed is:

1. A printer with a toner-based printing device, the printer comprising at least one air outlet, to which a filter is fastened exchangeably, for the outflow of the gas contained in the printer into the surroundings, characterized in that the filter comprises at least one electrostatically active filter ply.

2. The printer as claimed in claim 1, wherein the at least one filter ply is formed from nonwoven.

3. The printer as claimed in claim 1, wherein the filter is designed as a folded filter.

4. The printer as claimed in claim 1, wherein the filter comprises at least three filter plies, the middle filter ply of which is the electrostatically active filter ply.

5. The printer as claimed in claim 1, wherein the filter comprises a ply equipped with activated charcoal.

6. The printer as claimed in claim 1, wherein the filter comprises a frame consisting of nonwoven which is adhesively bonded to the at least one filter ply.

7. The printer as claimed in claim 1, wherein plastic angles are provided on the end faces of the filter.

8. The printer as claimed in claim 7, wherein the plastic angles have a face which points in the direction of the printer and which is equipped with an adhesive strip.
